(19) United States
(12) Patent Application Publication
(10) Pub. No.: US 2023/0121919 A1
(43) Pub. Date: Apr. 20, 2023

(54) METHOD FOR GENERATING MACHINING CUTTER PATH FOR CURVED DEEP CAVITY SURFACE

(71) Applicant: CHENGDU USEFUL TECHNOLOGY CO., LTD, Chengdu (CN)

(72) Inventor: Shifei DAI, Chengdu (CN)

(21) Appl. No.: 17/868,415

(22) Filed: Jul. 19, 2022

(30) Foreign Application Priority Data
Oct. 14, 2021 (CN) 202111200954.3

(51) Int. Cl. G05B 19/19

(52) U.S. Cl. CPC G05B 19/19; G05B 2219/35349; G05B 2219/36087

(57) ABSTRACT

A method for generating a machining cutter path for a curved deep cavity surface is provided, which relates to the technical field of generation of machining cutter paths for curved deep cavity surface to solve the problems of low machining efficiency and high rejection rate of thin-walled parts with curved deep cavity surface due to complex cutter paths in the prior art. The method includes the following steps: extracting a boundary contour of a curved deep cavity surface and generating an initial cutter path; considering a machine tool limitation constraint; considering a non-interference constraint; considering a non-chattering constraint, and determining a feasible region of the cutter axis vector with the consideration of the non-chattering constraint; determining feasible region of the cutter axis vector for each cutter location point; and outputting an optimized cutter path.

### CROSS REFERENCE TO RELATED APPLICATION

This patent application claims the benefit and priority of Chinese Patent Application No. 202111200954.3, entitled “METHOD FOR GENERATING MACHINING CUTTER PATH FOR CURVED DEEP CAVITY SURFACE” filed on Oct. 14, 2021, the disclosure of which is incorporated by reference herein in its entirety as part of the present application.

### TECHNICAL FIELD

The present disclosure relates to the technical field of generation of machining cutter paths for curved deep cavity surface, especially generation of machining tool paths for thin-walled parts with curved deep cavity surface such as connectors, and in particular, to a method for generating a machining cutter path for a curved deep cavity surface.

### BACKGROUND

At present, the manufacturing industrial system is in a critical period of transforming from a manufacturer of quantity to one of quality. The most important part of the manufacturing industry includes the aerospace manufacturing industry of which the development level is often a sign indicating whether a country is advanced in science and technology. In the aerospace field, a large number of thin-walled parts are used to manufacture equipment, resulting in increasing demand for thin-walled parts with curved deep cavity surface such as aerospace connectors.

However, strict requirements are imposed on the machining process of thin-walled parts with curved deep cavity surface like connectors. In addition to one-step forming and no chatter marks, high ability of process programmers is also required. Therefore, due to different abilities between process programmers, usually the programmed cutter paths may result in low machining efficiency or may lead to a lot of chatter marks in parts to make the parts useless.

For a thin-walled part with curved deep cavity surface, solid cutout machining is adopted, which has a large machining allowance and may easily cause material deformation. Due to a deep cavity, the overhanging ratio of a cutter used in machining is generally more than 5:1 and sometimes even 15:1. Because of poor rigidity of a cutter and poor structural machinability of a workpiece itself, chattering and back-off of the cutter often take place during machining, resulting in uneven wall thickness of the workpiece. During machining of a bottom surface, the clasp-cutter phenomenon may occur even though a small helix angle of entry is adopted. This may seriously affect the surface quality of the workpiece and the machining efficiency and even make the workpiece useless. In finish milling, even though multiple feeds are performed, the cutter may chatter violently due to its small diameter and great overhanging ratio. Especially at a circular arc of the bottom surface, since the stress on the cutter increases suddenly, the cutter is often broken, resulting in useless workpiece.

To sum up, in the traditional machining method for thin-walled parts with deep cavity surface, a large-diameter solid milling cutter is used for rough milling and then a smaller-diameter end milling cutter is used for finish milling. Due to the structural constraint of deep cavity, multiple feeds are required for machining. Thus, the cutter paths for thin-walled parts with deep cavity surface may be complex, thus resulting in problems of low machining efficiency and high rejection rate. To solve the above technical problems, there is provided a method for generating a machining cutter path for a curved deep cavity surface.

### SUMMARY

The purpose of the present disclosure is: to solve the problems of low machining efficiency and high rejection rate of thin-walled parts with deep cavity surface due to multiple feeds and complex cutter paths in the prior art, the present disclosure provides a method for generating a machining cutter path for a curved deep cavity surface. By using an optimization method of a machining cutter path for a curved deep cavity surface that takes into account machine limitation, non-interference and non-chattering constraints, multiple feeds are not needed for machining of a curved deep cavity surface. Thus, the problems of useless workpieces due to the lack of experience of a technician and the like are solved, thus reducing the probability of repair, reducing the labor needed and improving the machining efficiency.

To achieve the above objective, the present disclosure specifically adopts the following technical solutions:

A method for generating a machining cutter path for a curved deep cavity surface includes the following steps:

extracting a boundary contour of a curved deep cavity surface and generating an initial cutter path: completing extraction of the boundary contour of features of the curved deep cavity surface, and generating the initial cutter path based on a method of isometric offset from the boundary contour,

where extracting a boundary contour of a curved deep cavity surface and generating an initial cutter path may include the following steps:

selecting a curved deep cavity surface and extracting the boundary contour of the curved deep cavity surface;

generating an offset line based on an isometric offset from the boundary contour according to the boundary contour; and

determining a preferential machining direction and a preferential cutter feeding direction, starting cutter feeding from the upper left of a cutter track, moving the cutter along the offset line, judging whether the offset line is connected with the boundary, and if not, breaking a disconnected line segment to obtain the initial cutter path;

optimizing the initial cutter path according to a selected cutter, performing judgment on an irregular cutter track segment, setting an effective cutting radius of the cutter as Rₑ and an isometric cutting width as CW, and if Rₑ>CW, directly connecting the tail of an anterior cutter track to a next cutter track to reduce repeated milling; and

generating the cutter location file according to optimized initial cutter path, where the cutter location file includes cutter information, a feeding speed, a rotating speed, a cutter location point and a cutter axis vector, with the cutter location point and the cutter axis vector for determining a position and a posture of the cutter in three-dimensional space; and the cutter location file needs to take into account whether the position and the posture of the cutter at each cutter location point are located within a range defined by a machine tool limitation constraint, the non-interference constraint and the non-chattering constraint.

Considering a machine tool limitation constraint: inversely deriving a corresponding feasible region of cutter axis vector based on a swing angle range of each corresponding rotating shaft of a machine tool selected,

where considering a machine tool limitation constraint may include the following steps:

selecting a corresponding machine tool according to a part to be machined, and setting a rotation stroke of a shaft A of the machine tool as −120° to +60° and a rotation stroke of a shaft B as −360° to +360°;

setting a workpiece coordinate system as O_{W}−X_{W}Y_{W}Z_{W}, a feeding coordinate system as O_{F}−FCN, and a cutter coordinate system as O_{T}−X_{T}Y_{T}Z_{T}, wherein the cutter coordinate system is obtained by rotating the feeding coordinate system about an intersecting feeding shaft C by l first and then about a feeding shaft F by t; and a matrix of transformation from the cutter coordinate system to the feeding coordinate system is shown below:

$${T}_{T - F} = [ \begin{matrix}1 & 0 & 0 \\ 0 & cost & - sint \\ 0 & sint & cost\end{matrix} ] [ \begin{matrix}cosl & 0 & sinl \\ 0 & 1 & 0 \\ - sinl & 0 & cosl\end{matrix} ] ;$$

establishing a relational equation of the cutter axis vector, the shaft A and the shaft B of the machine tool according to relations of a specific mechanism and a kinematic chain of the machine tool with the workpiece coordinate system, the feeding coordinate system and the cutter coordinate system:

T_{W-ta}=(sin B,−cos B sin A,cos B cos A)^{T},

where T represents a torque of the matrix, while A represents a rotation angle of the shaft A of the machine tool, B represents a rotation angle of the shaft B of the machine tool, and T_{W-ta} represents a matrix of transformation from a rotation angle of the machine tool to a cutter axis vector;

an equation of the feeding coordinate system is:

$$\{ \begin{matrix}{F}_{( i , k )} = \frac{{CC}_{( i + 1 , k )} - {CC}_{( i , k )}}{\vert {CC}_{( i + 1 , k )} - {CC}_{( i , k )} \vert} \\ {N}_{( i , k )} = ( {n}_{i} , {n}_{j} , {n}_{k} ) \\ {C}_{( i , k )} = {N}_{( i , k )} \times {F}_{( i , k )} \\ {O}_{F ( i , k )} = {CC}_{( i , k )} + R * {N}_{( i , k )}\end{matrix}$$

where CC_{(i+1,k)} and CC_{(i,k)} represent two successive cutter contact points in the k-th cutter path, while N_{(i,k)} represents a surface normal vector of the tool at current cutter location point, C_{(i,k)} represents an intersecting feeding direction at the current cutter location point CL_{(i,k)}; O_{F}_{_{(i,k)}} represents an origin of the feeding coordinate system, F_{(i,k)} represents a feeding direction at i-th cutter location point in the k-th cutter path, R represents a radius of a ball-end milling cutter, and nᵢ, nⱼ and nₖ represent coordinate values of the surface normal vector;

defining feeding coordinates in the workpiece coordinate system, and a transformational relation between the feeding coordinates and the workpiece coordinate system is:

T_{F→W}=[F_{(i,k)}|C_{(i,k)}|N_{(i,k)}]_{3×3}

where [ ]_{3×3} represents a third-order matrix composed of the feeding direction, the intersecting feeding direction and the surface normal vector at the i-th cutter location point in the k-th cutter path;

the relational equation of the cutter axis vector with the shaft A and the shaft B of the machine is:

T_{W-ta}=T_{W-F}(T_{T-F})^{T},

where T_{W-F} represents a matrix of transformation from the workpiece coordinate system to the feeding coordinate system, while T_{T-F} represents the matrix of transformation from the cutter coordinate system to the feeding coordinate system, W represents the workpiece coordinate system, and T represents the torque of the matrix; and

determining feasible regions of a front rake angle and a side rake angle corresponding to the cutter axis vector under the machine tool limitation constraint by combining the rotation stroke of the shaft A and the rotation stroke of the shaft B of the machine tool with the relational equation of the cutter axis vector with the shaft A and the shaft B of the machine tool.

Considering a non-interference constraint: considering global interference and local interference of a cutter during machining, performing non-interference determination by considering the cutter having a tool holder clamping the cutter as a whole, and determining a feasible region of cutter axis vector with consideration of the non-interference constraint,

where considering a non-interference constraint may include the following steps:

detecting and avoiding interference at the beginning of path generation, and considering potential interference of the cutter with a curved workpiece surface;

considering interference detection performed after clamping the cutter by the cutter holder, and g a formula of radius variation of the cutter along the cutter axis in a cutting plane of axis Z of the cutter coordinate system O_{T}−X_{T}Y_{T}Z_{T} is:

$$r ( z ) = \{ \begin{matrix}{R}_{1} + \sqrt{{R}_{2}^{2} - {z}^{2}} , - {R}_{2} \leq z \leq 0 \\ {R}_{1} + {R}_{2} , 0 < z < {L}_{1} \\ \frac{{R}_{4} ( {L}_{1} + {L}_{2} - z ) + {R}_{3} ( z - {L}_{1} )}{{L}_{2}} , {L}_{1} < z < {L}_{1} + {L}_{2} \\ {R}_{4} , {L}_{1} + {L}_{2} < z < {L}_{1} + {L}_{2} + {L}_{3} \\ {R}_{5} , {L}_{1} + {L}_{2} + {L}_{3} < z < {L}_{1} + {L}_{2} + {L}_{3} + {L}_{4}\end{matrix}$$

where r(z) is a radius at a different height along the cutter axis, while L₁ represents a length of the cutter holder, L₂, L₃, L₄ represent lengths of different portions of a heat-shrinkable tool holder, R₁ and R₂ represent a bottom face corner radius and a cutter radius of an annular milling cutter, and R₃, R₄, R₅ represent radius values of different portions of the heat-shrinkable cutter holder;

discretizing the curved deep cavity surface into a point cloud according to a certain accuracy requirement, judging whether each point in the point cloud falls inside the curved cutter surface, confirming that interference occurs between the cutter and the curved workpiece surface if at least one point in the point cloud is inside the cutter; otherwise, confirming no interference occurs;

for any point Pin the point cloud data of the curved deep cavity surface, setting P′ as a projection of the point P on the cutter axis, and expressing P′ as:

P′=O_{T}+λ·ta

where ta is the cutter axis vector, while λ is a coefficient of a distance from P′ to the origin O_{T} of the cutter coordinate system;

obtaining the z coordinate value of the P projection on the cutter axis after obtaining P′, substituting the z coordinate value into the formula of radius variation of the cutter along the cutter axis, confirming that the point is in space outside two ends of the cutter if the value of z is not within the range of the formula of radius variation of the cutter along the cutter axis, and in this case, confirming that the point is not within the curved cutter surface and no interference occurs; if the value of z is within the range of the formula of radius variation of the cutter along the cutter axis, substituting the value of z into the formula of radius variation of the cutter along the cutter axis for calculation, if |PP′|≥r(z) determining that the point P is located outside the curved cutter surface and no interference occurs; otherwise, determining that interference occurs;

changing the cutter axis vector, determining whether interference occurs for the cutter axis vector, and if no interference occurs, recording the posture of the cutter and constructing a feasible region of cutter posture without interference.

Considering a non-chattering constraint: obtaining an intersecting area of the cutter and workpiece, constructing a dynamic model, constructing a stability diagram by using a full-discrete method, and determining a feasible region of cutter axis vector with consideration of the non-chattering constraint;

where considering a non-chattering constraint may include the following steps:

obtaining a posture stability diagram based on a contact area of the cutter and workpiece, and determining a feasible region of cutter posture for stable machining;

based on NX12.0 secondary development, extracting the contact area of the cutter and workpiece at each cutter location point during machining, and obtaining a cut-in and cut-out angle of each cutting infinitesimal element at this cutter location point through an equation

$${ϕ}_{b} = arc tan ( \frac{{x}_{{P}_{b}}}{{y}_{{P}_{b}}} ) , 0 \leq {ϕ}_{b} \leq 2 π ,$$

wherein ϕ_{b} represents an immersion angle, while xp_{b} represents x coordinate value of any point P_{b}, and yp_{b} represents y coordinate value of any point P_{b};

for a cutter location point, extracting the contact area once through NX12.0 secondary development application; and

after obtaining the contact area, obtaining the posture stability diagram by combining a universal cutting model of a milling cutter and the full-discrete method, thereby obtaining the feasible region of cutter posture for stable machining.

Determining a feasible region of cutter axis vector for each cutter location point: finding an intersection of the feasible region of cutter axis vector obtained with consideration of the machine tool limitation constraint, the feasible region of cutter axis vector obtained with consideration of the non-interference constraint and the feasible region of cutter axis vector obtained with consideration of the non-chattering constraint to obtain an actual feasible region of cutter axis vector for each cutter location point; and

optimizing a shortest path and outputting an optimized cutter path: determining a cutter axis vector corresponding to each cutter location point from the feasible region of cutter axis vector based on a Dijkstra shortest path fairing method, generating a cutter location file, selecting corresponding post-processing according to an actual machine tool and outputting a final optimized cutter path,

where optimizing a shortest path and outputting an optimized cutter path may include the following steps:

after obtaining the feasible regions of cutter axis vector for each cutter location point based on the machine tool limitation constraint, the non-interference constraint and the non-chattering constraint, outputting the optimized cutter path, which requires confirmation of the exact cutter axis vector corresponding to each cutter location point;

determining the cutterl axis vector corresponding to each cutter location point based on the Dijkstra shortest path fairing method, and outputting the optimized cutterl location file; and

selecting corresponding post-processing according to the actual machine tool and outputting the final optimized cutter path.

The present disclosure has the following beneficial effects:

In the present disclosure, by using an optimization method of a machining cutter path for a curved deep cavity surface that takes into account machine tool limitation, non-interference and non-chattering constraints, multiple feeds are not needed for machining of a curved deep cavity surface. Thus, the problems of useless workpieces due to the lack of experience of a technician and the like are solved, thus reducing the probability of repair, reducing the labor needed and improving the machining efficiency.

### BRIEF DESCRIPTION OF THE DRAWINGS

FIG. 1 is a flowchart according to the present disclosure.

FIG. 2 is a schematic diagram illustrating extraction of a boundary contour of a curved deep cavity surface according to the present disclosure.

FIG. 3 is a schematic diagram illustrating generation of an initial cutter path according to the present disclosure.

FIG. 4 is a schematic diagram illustrating coordinate system establishment according to the present disclosure.

FIG. 5 is a schematic diagram illustrating relations of a workpiece coordinate system, a cutter coordinate system and a feeding coordinate system according to the present disclosure.

FIG. 6 is a schematic diagram illustrating a geometric model of the universal milling cutter according to the present disclosure.

FIG. 7 is a schematic diagram illustrating point cloud discretizing interference detection of a curved deep cavity surface according to the present disclosure.

FIG. 8 is a schematic diagram illustrating conditions of a cutter geometry and a workpiece geometry at a cutter location point during machining driven by a numerical control (NC) program according to the present disclosure.

FIG. 9 is a schematic diagram illustrating two-dimensional contact of an extracted intersection and a ball-end cutter according to the present disclosure.

FIG. 10 is a schematic diagram illustrating finding an intersection of a discrete layer and the boundaries of an intersecting area according to the present disclosure.

FIG. 11 is a schematic diagram illustrating a resulting intersection point set and deriving of coordinates of the point set according to the present disclosure.

FIG. 12 is a schematic diagram illustrating a feasible region cone at a cutter location point in a cutter path according to the present disclosure.

FIG. 13 is a schematic diagram illustrating an output cutter path according to the present disclosure.

### DETAILED DESCRIPTION OF THE EMBODIMENTS

In order to make the objectives, technical solutions and advantages of the embodiments of the present disclosure more clear, the technical solutions in the embodiments of the present disclosure will be clearly and completely described below in conjunction with the accompanying drawings in the embodiments of the present disclosure. Obviously, the described embodiments are some, rather than all of the embodiments of the present disclosure.

### Embodiment 1

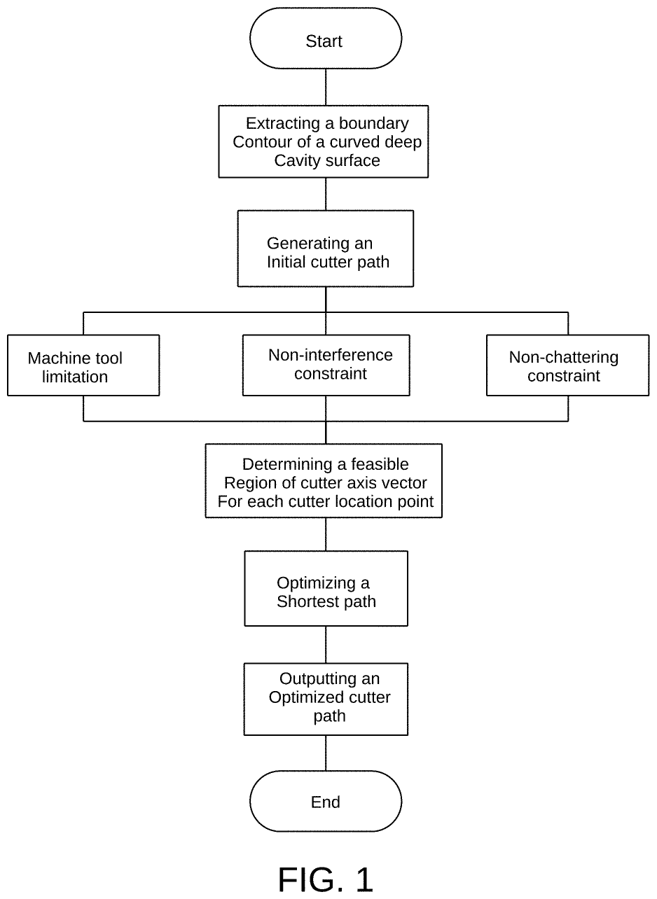

As shown in FIG. 1, a method for generating a machining cutter path for a curved deep cavity surface includes the following steps:

Extracting a boundary contour of a curved deep cavity surface and generating an initial cutter path: completing extraction of the boundary contour of features of the curved deep cavity surface, and generating the initial cutter path based on a method of isometric offset from the boundary contour.

The step of extracting a boundary contour of a curved deep cavity surface and generating an initial cutter path specifically includes the following steps:

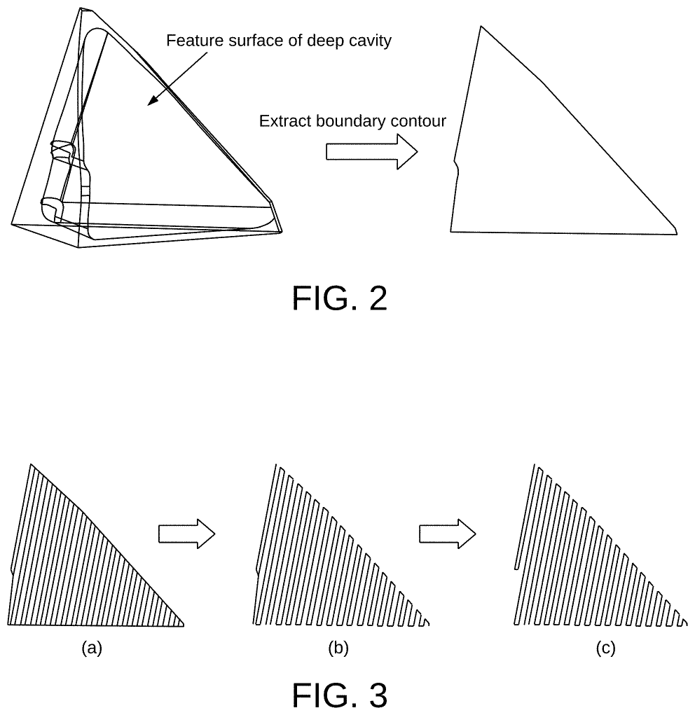

based on NX12.0 secondary development function, as shown in FIG. 2, selecting a curved deep cavity surface, and extracting the boundary contour of the curved deep cavity surface by the NX12.0 secondary development function to create the premise for generating the initial cutter path;

in FIG. 3, (a) is a schematic diagram of an initial offset cutter path; as shown in FIG. 3(a), extracting a specific boundary according to the boundary contour and generating an offset line based on an isometric offset of the boundary contour; and

determining a preferential machining direction and a preferential feeding direction, as shown in FIG. 3(b) which is a schematic diagram of an initial simplified cutter path, starting feeding from the upper left of a cutter track, moving along the offset line, judging whether the offset line is connected with the boundary, and if not, breaking a disconnected line segment to obtain the initial cutter path.

Optimize the initial cutter path according to a selected cutter, performing judgment on an irregular cutter track segment in FIG. 3(b), setting an effective cutting radius of the cutter as Rₑ and an isometric cutting width as CW, and if Rₑ>CW^{R}^{ₑ}^{>CW}, directly connecting the tail of an anterior cutter track to the next cutter track to reduce repeated milling, with the optimization result shown in FIG. 3(c); and

generating the cutter location file according to the optimized initial cutter path, where the cutter location file includes cutter information, a feeding speed, a rotating speed, a cutter location point and a cutter axis vector, with the cutter location point and the cutter axis vector being most critical and used for determining a position and a posture of the cutter a in three-dimensional space (as shown in FIG. 1); and the cutter location file needs to take into account whether the position and the posture of the cutter at each cutter location point are located within a range defined by the machine tool limitation constraint, the non-interference constraint and the non-chattering constraint.

Table 1 shows the cutter location file.

| | x | y | z | i | j | k |
|---|---|---|---|---|---|---|
| GOTO/ | −5.7731, | 100.5000, | 16.6260, | −0.1187550, | 0.2474177, | 0.9616037 |
| GOTO/ | −5.7099, | 100.5000, | 16.6459, | −0.1187836, | 0.2475348, | 0.9615700 |
| GOTO/ | −5.2045, | 100.5000, | 16.8054, | −0.1189380, | 0.2484731, | 0.9613090 |
| GOTO/ | −3.1828, | 100.5000, | 17.4453, | −0.1182368, | 0.2522425, | 0.9604133 |
| GOTO/ | 0.8607, | 100.5000, | 18.7187, | −0.1094127, | 0.2597913, | 0.9594464 |
| GOTO/ | 6.4609, | 100.5000, | 20.3862, | −0.0835989, | 0.2703594, | 0.9591230 |

Considering a machine tool limitation constraint: inversely deriving a corresponding feasible region of cutter axis vector based on a swing angle range of each corresponding rotating shaft of a machine tool selected.

The step of considering a machine tool limitation constraint specifically includes the following steps:

selecting a corresponding machine tool according to a part to be machined (for example, for a curved deep cavity surface connector part selecting a Shanghai Tuopu five-axis equipment (vertical-horizontal conversion) HMC-ClOOP in the present disclosure), and setting a rotation stroke of a shaft A of the machine tool as −120° to +60° and a rotation stroke of a shaft B as −360° to +360°;

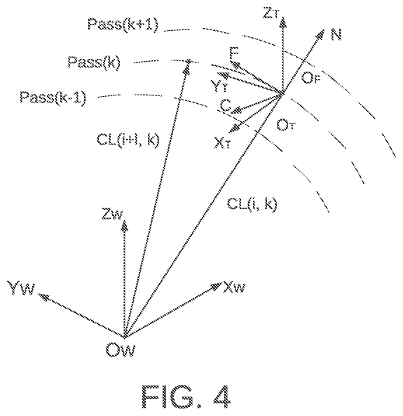

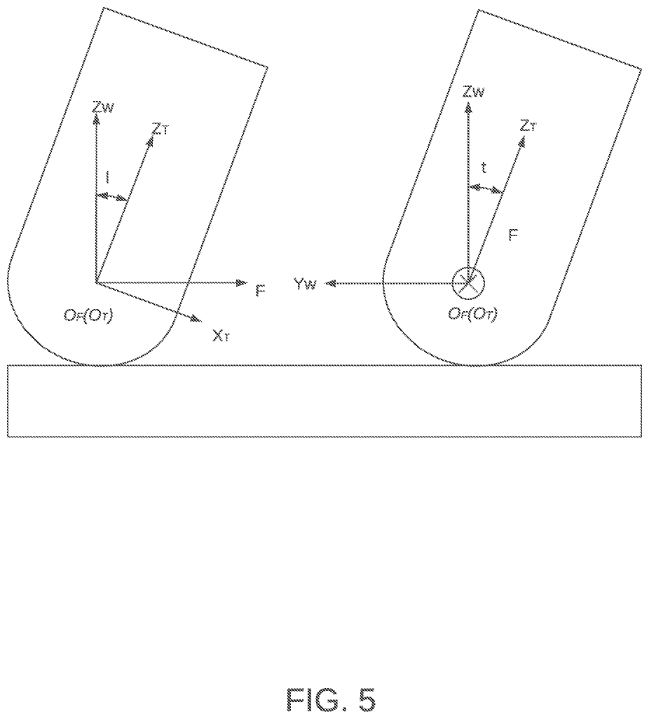

as shown in FIG. 4 and FIG. 5, pass (k), pass (k−1) and pass (k+1) represent respectively k-th, (k−1)-th and (k+1)-th cutter paths in FIG. 4, setting a workpiece coordinate system as O_{W}−X_{W}Y_{W}Z_{W}, a feeding coordinate system as O_{F}−FCN, and a cutter coordinate system as O_{T}−X_{T}Y_{T}Z_{T}, where the cutter coordinate system is obtained by rotating the feeding coordinate system about an intersecting feeding shaft C by l first and then about a feeding shaft F by t; and a matrix of transformation from the cutter coordinate system to the feeding coordinate system is shown below:

$${T}_{T - F} = [ \begin{matrix}1 & 0 & 0 \\ 0 & cost & - sint \\ 0 & sint & cost\end{matrix} ] [ \begin{matrix}cosl & 0 & sinl \\ 0 & 1 & 0 \\ - sinl & 0 & cosl\end{matrix} ] ;$$

establishing a relational equation of the cutter axis vector, the shaft A and the shaft B of the machine tool according to relations of a specific mechanism and a kinematic chain of the AB type five-axis machine tool with the workpiece coordinate system, the feeding coordinate system and the cutter coordinate system:

T_{W-ta}=(sin B,−cos B sin A,cos B cos A)^{T},

where T represents a torque of the matrix, while A represents a rotation angle of the shaft A of the machine tool, B represents a rotation angle of the shaft B of the machine tool, and T_{W-ta} represents a matrix of transformation from a rotation angle of the machine tool to a cutter axis vector;

similarly, establishing an equation of the feeding coordinate system:

$$\{ \begin{matrix}{F}_{( i , k )} = \frac{{CC}_{( i + 1 , k )} - {CC}_{( i , k )}}{\vert {CC}_{( i + 1 , k )} - {CC}_{( i , k )} \vert} \\ {N}_{( i , k )} = ( {n}_{i} , {n}_{j} , {n}_{k} ) \\ {C}_{( i , k )} = {N}_{( i , k )} \times {F}_{( i , k )} \\ {O}_{F ( i , k )} = {CC}_{( i , k )} + R * {N}_{( i , k )}\end{matrix}$$

where CC_{(i+1,k)} and CC_{(i,k)} represent two successive cutter contact points in the k-th cutter path, while N_{(i,k)} represents a surface normal vector of the tool at the current cutter location point, C_{(i,k)} represents an intersecting feeding direction at the current cutter location point CL_{(i,k)}, O_{F}_{_{(i,k)}} represents an origin of the feeding coordinate system, F_{(i,k)} represents a feeding direction at the i-th cutter location point in the k-th cutter path, R represents a radius of a ball-end milling cutter, and nᵢ, nⱼ and nₖ represent coordinate values of the surface normal vector;

defining feeding coordinates in the workpiece coordinate system, and determining a transformational relation between the feeding coordinates and the workpiece coordinate system as:

T_{F→W}=[F_{(i,k)}|C_{(i,k)}|N_{(i,k)}]_{3×3}

where [ ]_{3×3} represents a third-order matrix composed of the feeding direction, the intersecting feeding direction and the surface normal vector at the i-th cutter location point in the k-th cutter path;

the relational equation of the cutter axis vector with the shaft A and the shaft B of the machine tool is:

T_{W-ta}=T_{W-F}(T_{T-F})^{T},

where T_{W-F} represents a matrix of transformation from the workpiece coordinate system to the feeding coordinate system, while T_{T-F} represents the matrix of transformation from the cutter coordinate system to the feeding coordinate system, W represents the workpiece coordinate system, and T represents the torque of the matrix; and

determining feasible regions of a front rake angle and a side rake angle corresponding to the cutter axis vector under the machine tool limitation constraint by combining the rotation stroke of the shaft A and the rotation stroke of the shaft B of the machine tool with the relational equation of the cutter axis vector with the shaft A and the shaft B of the machine tool.

Considering a non-interference constraint: considering global interference and local interference of a cutter during machining, performing non-interference determination by considering a cutter having a tool holder clamping the cutter as a whole, and determining a feasible region of cutter axis vector with the consideration of the non-interference constraint.

The step of considering a non-interference constraint specifically includes the following steps:

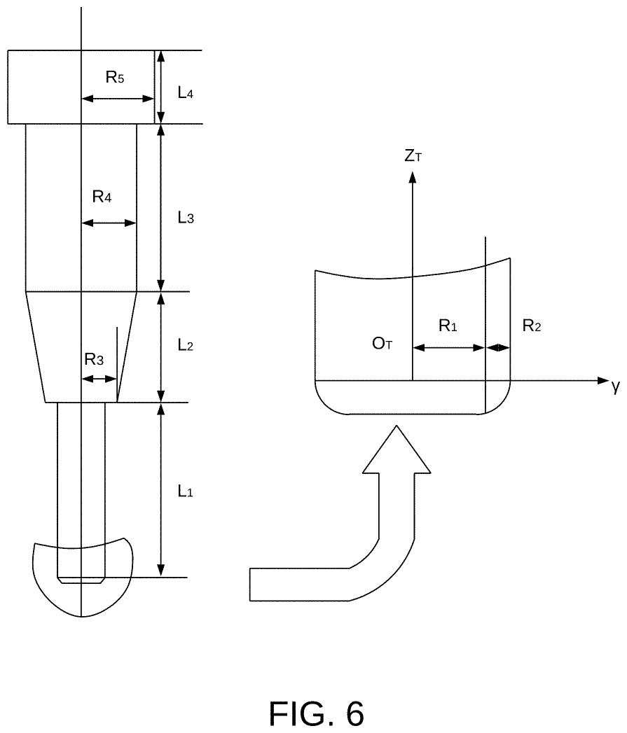

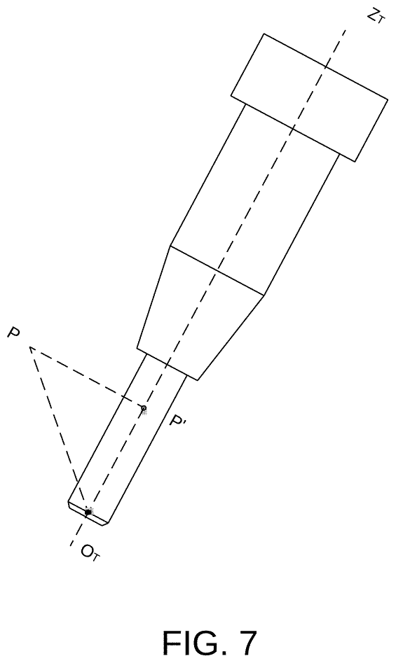

detecting and avoiding interference at the beginning of path generation, and consider potential interference of the cutter with the curved workpiece surface. The best time to detect and avoid interference is at the five-axis paths planning stage, and a ring-like cutter is selected as a uniform cutter model for machining path planning in the present disclosure, as shown in FIG. 6.

For machining of a curved deep cavity surface as a connector, considering interference detection performed after clamping the cutter by the tool holder because the integrated cutter may go deep into the deep cavity area, and as shown in FIG. 6, a formula of radius variation of the cutter along the cutter axis in a cutting plane of axis Z of the cutter coordinate system O_{T}−X_{T}Y_{T}Z_{T} is:

$$r ( z ) = \{ \begin{matrix}{R}_{1} + \sqrt{{R}_{2}^{2} - {z}^{2}} , - {R}_{2} \leq z \leq 0 \\ {R}_{1} + {R}_{2} , 0 < z < {L}_{1} \\ \frac{{R}_{4} ( {L}_{1} + {L}_{2} - z ) + {R}_{3} ( z - {L}_{1} )}{{L}_{2}} , {L}_{1} < z < {L}_{1} + {L}_{2} \\ {R}_{4} , {L}_{1} + {L}_{2} < z < {L}_{1} + {L}_{2} + {L}_{3} \\ {R}_{5} , {L}_{1} + {L}_{2} + {L}_{3} < z < {L}_{1} + {L}_{2} + {L}_{3} + {L}_{4}\end{matrix}$$

where r(z) is a radius at a different height along the cutter axis, while L₁ represents a length of the cutter holder, L₂, L₃, L₄ represent lengths of different portions of a heat-shrinkable tool holder, R₁ and R₂ represent a bottom face corner radius and a cutter radius of an annular milling cutter, and R₃, R₄, R₅ represent radius values of different portions of the heat-shrinkable cutter holder;

discretizing the curved deep cavity surface into a point cloud according to a certain accuracy requirement, judging whether each point in the point cloud falls inside the curved cutter surface, confirming that interference occurs between the cutter and the curved workpiece surface if at least one point in the point cloud is inside the cutter; otherwise, confirm no interference;

as shown in FIG. 7, for any point P in the point cloud data of the curved deep cavity surface, setting P′ as a projection of the point P on the cutter axis, and expressing P′ as:

P′=O_{T}+λ·ta

where ta is the cutter axis vector, while is a coefficient of a distance from P′ to the origin O_{T} of the cutter coordinate system;

obtaining the z coordinate value of the P projection on the cutter axis after obtaining P′, substitute the z coordinate value into the formula of radius variation of the cutter along the cutter axis, confirming that the point is in space outside two ends of the cutter if the value of z is not within the range of the formula of radius variation of the cutter along the cutter axis, and in this case, confirming that the point is not within the curved tool surface and no interference occurs; if the value of z is within the range of the formula of radius variation of the cutter along the cutter axis, substitute the value of z into the formula of radius variation of the cutter along the cutter axis for calculation, if |PP′|≥r(z), determining that the point P is located outside the curved cutter surface and no interference occurs; otherwise, determining that interference occurs; and

changing the cutter axis vector, determining whether interference occurs for the cutter axis vector, and if no interference occurs, record the posture of the cutter and constructing a feasible region of cutter posture without interference.

Considering a non-chattering constraint: obtaining an intersecting area of a cutter and workpiece, constructing a dynamic model, constructing a stability diagram by using a full-discrete method, and determining a feasible region of cutter axis vector with consideration of the non-chattering constraint.

The step of considering a non-chattering constraint specifically includes the following steps:

to solve the urgent problem of the non-chattering constraint in machining of a curved deep cavity surface as a connector, obtaining a posture stability diagram based on a contact area of the cutter and workpiece, and determining a feasible region of cutter posture for stable machining;

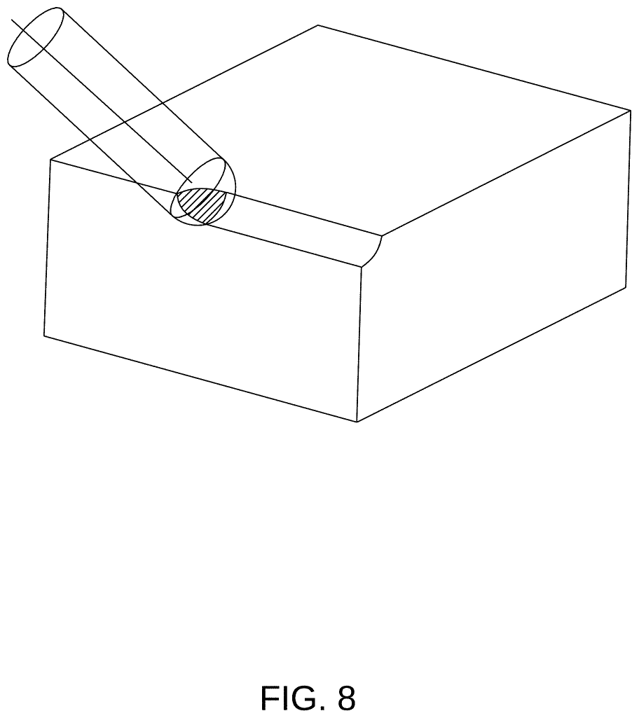

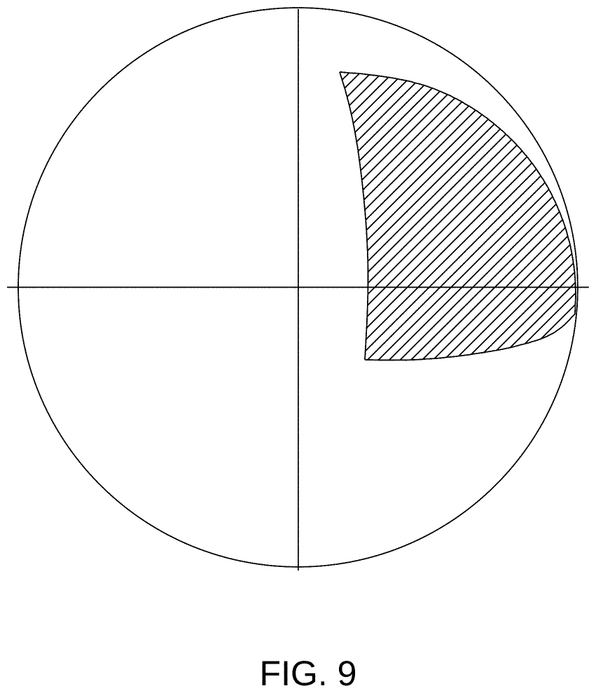

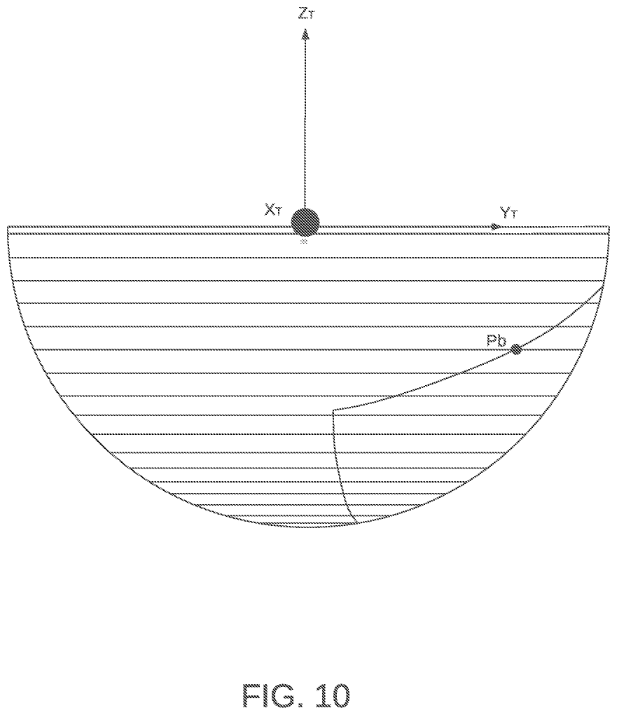

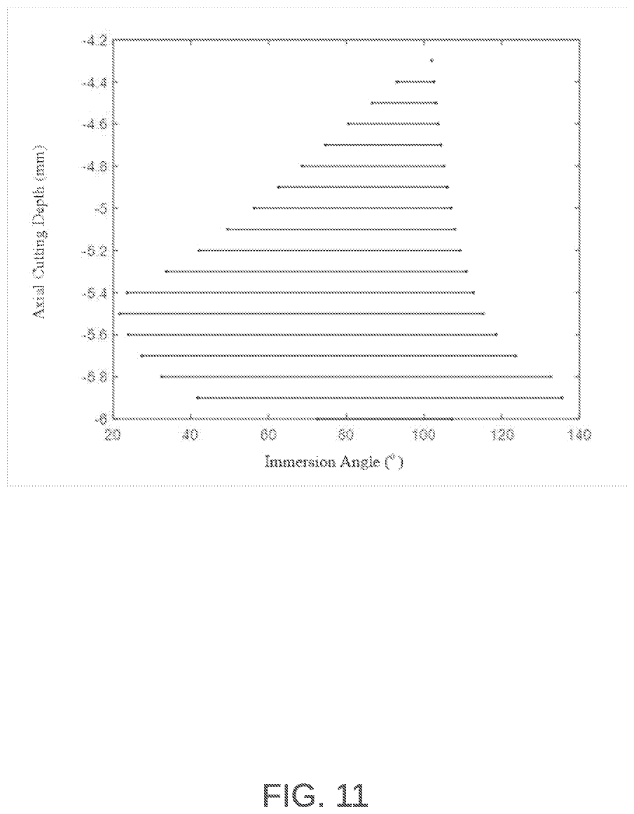

as shown in FIG. 8 to FIG. 11, for the convenience of calculation and integration into NX12.0, based on NX12.0 secondary development, extracting the contact area of the cutter and workpiece at each cutter location point during machining, and obtaining a cut-in and cut-out angle of each cutting infinitesimal element at this cutter location point through an equation

$${ϕ}_{b} = arc tan ( \frac{{x}_{{P}_{b}}}{{y}_{{P}_{b}}} ) , 0 \leq {ϕ}_{b} \leq 2 π ,$$

wherein ϕ_{b} represents an immersion angle, while xp_{b} represents x coordinate value of any point P_{b}, and yp_{b} represents y coordinate value of any point P_{b};

for a cutter location point, extracting the contact area once through NX12.0 secondary development application, i.e., obtaining a contact area under any cutter posture at this cutter location point so as to significantly improve the extraction efficiency; and

after obtaining the contact area, obtaining the posture stability diagram by combining a universal cutting model of a milling cutter and the full-discrete method, thereby obtaining the feasible region of cutter posture for stable machining.

Determining a feasible region of cutter axis vector for each cutter location point: finding an intersection of the feasible regions of cutter axis vector obtained with the consideration of the machine tool limitation constraint, the non-interference constraint and the non-chattering constraint to obtain an actual feasible region of cutter axis vector for each cutter location point; and

optimizing a shortest path and outputting an optimized cutter path: determining a cutter axis vector corresponding to each cutterl location point from the feasible region of cutter axis vector based on a Dijkstra shortest path fairing method, generating a cutter location file, selecting corresponding post-processing according to an actual machine tool and outputting a final optimized cutter path.

The step of optimizing a shortest path and outputting an optimized cutter path specifically includes the following steps:

after obtaining the feasible region of cutter axis vector for each cutter location point based on the machine tool limitation constraint, the non-interference constraint and the non-chattering constraint, outputting the optimized cutter path, which requires confirmation of the exact cutter axis vector corresponding to each cutter location point;

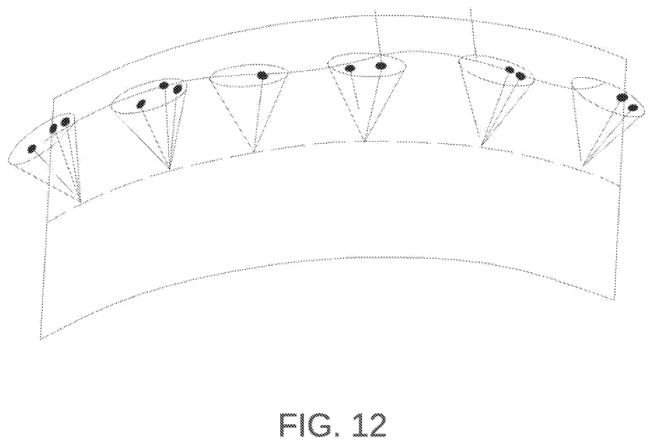

with reference to FIG. 12 which shows the final feasible region at each cutter location point in a cutter path, determining the cutter axis vector corresponding to each cutter location point based on the Dijkstra shortest path fairing method, and outputting the optimized cutter location file; and

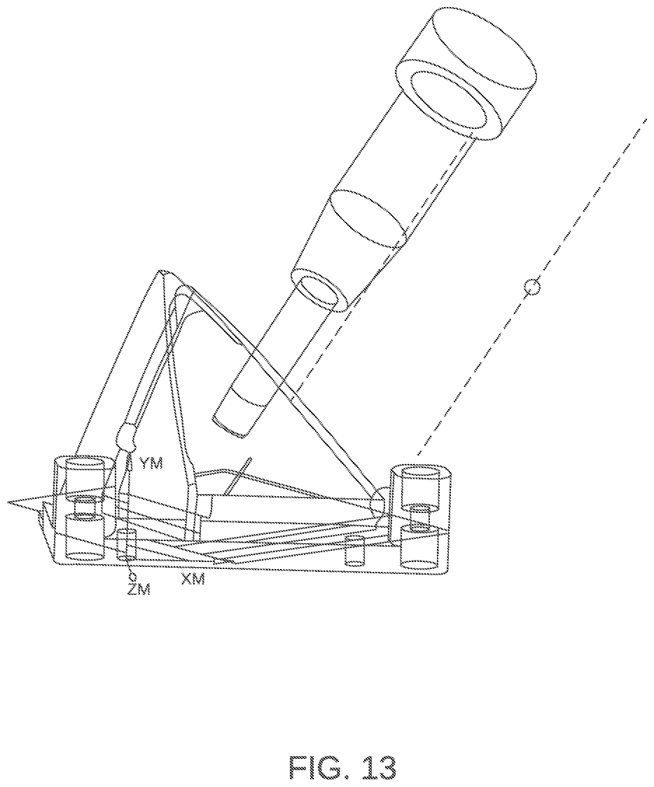

as shown in FIG. 13, selecting corresponding post-processing according to the actual machine tool and outputting the final optimized cutter path.

What is claimed is:

1. A method for generating a machining cutter path for a curved deep cavity surface, comprising following steps:
extracting a boundary contour of a curved deep cavity surface and generating an initial cutter path: completing extraction of the boundary contour of features of the curved deep cavity surface, and generating the initial cutter path based on a method of isometric offset from the boundary contour;
considering a machine tool limitation constraint: inversely deriving a corresponding feasible region of cutter axis vector based on a swing angle range of each corresponding rotating shaft of a machine tool selected;
considering a non-interference constraint: considering global interference and local interference of a cutter during machining, performing non-interference determination by considering the cutter having a cutter holder clamping the cutter as a whole, and determining a feasible region of cutter axis vector with consideration of the non-interference constraint;
considering a non-chattering constraint: obtaining an intersecting area of the cutter and workpiece, constructing a dynamic model, constructing a stability diagram by using a full-discrete method, and determining a feasible region of cutter axis vector with consideration of the non-chattering constraint;
determining a feasible region of cutter axis vector for each cutter location point: finding an intersection of the feasible region of cutter axis vector obtained with consideration of the machine tool limitation constraint, the feasible region of cutter axis vector obtained with consideration of the non-interference constraint and the feasible region of cutter axis vector obtained with consideration of the non-chattering constraint, to obtain an actual feasible region of cutter axis vector for each cutter location point; and
optimizing a shortest path and outputting an optimized cutter path: determining a cutter axis vector corresponding to each cutter location point from the feasible region of cutter axis vector based on a Dijkstra shortest path fairing method, generating a cutter location file, selecting corresponding post-processing according to an actual machine tool and outputting a final optimized cutter path.

2. The method for generating a machining cutter path for a curved deep cavity surface according to claim 1, wherein extracting a boundary contour of a curved deep cavity surface and generating an initial cutter path comprises following steps:
selecting a curved deep cavity surface and extracting the boundary contour of the curved deep cavity surface;
generating an offset line based on an isometric offset from the boundary contour according to the boundary contour; and
determining a preferential machining direction and a preferential cutter feeding direction, starting cutter feeding from upper left of a cutter track, moving the cutter along the offset line, judging whether the offset line is connected with boundary, and if not, breaking a disconnected line segment to obtain the initial cutter path.

3. The method for generating a machining cutter path for a curved deep cavity surface according to claim 2, further comprising: optimizing the initial cutter path according to a selected cutter, performing judgment on an irregular cutter track segment, setting an effective cutting radius of the cutter as Rₑ and an isometric cutting width as CW, and if Rₑ>CW, directly connecting a tail of an anterior cutter track to a next cutter track to reduce repeated milling; and
generating the cutter location file according to optimized initial cutter path, wherein the cutter location file comprises cutter information, a feeding speed, a rotating speed, a cutter location point and a cutter axis vector, with the cutter location point and the cutter axis vector for determining a position and a posture of the cutter in a three-dimensional space; and the cutter location file needs to take into account whether the position and the posture of the cutter at each cutter location point are located within a range defined by the machine tool limitation constraint, the non-interference constraint and the non-chattering constraint.

4. The method for generating a machining cutter path for a curved deep cavity surface according to claim 1, wherein considering a machine tool limitation constraint comprises following steps:
selecting a corresponding machine tool according to a part to be machined, and setting a rotation stroke of a shaft A of the machine tool as −120° to +60° and a rotation stroke of a shaft B as −360° to +360°;
setting a workpiece coordinate system as O_{W}−X_{W}Y_{W}Z_{W}, a feeding coordinate system as O_{F}−FCN, and a cutter coordinate system as O_{T}−X_{T}Y_{T}Z_{T}, wherein the cutter coordinate system is obtained by rotating the feeding coordinate system about an intersecting feeding shaft C by l first and then about a feeding shaft F by t; and a matrix of transformation from the cutter coordinate system to the feeding coordinate system is shown below:
$${T}_{T - F} = [ \begin{matrix}1 & 0 & 0 \\ 0 & cost & - sint \\ 0 & sint & cost\end{matrix} ] [ \begin{matrix}cosl & 0 & sinl \\ 0 & 1 & 0 \\ - sinl & 0 & cosl\end{matrix} ] ;$$
establishing a relational equation of the cutter axis vector, the shaft A and the shaft B of the machine tool according to relations of a specific mechanism and a kinematic chain of the machine tool with the workpiece coordinate system, the feeding coordinate system and the cutter coordinate system:
T_{W-ta}=(sin B,−cos B sin A,cos B cos A)^{T},
wherein T represents a torque of the matrix, while A represents a rotation angle of the shaft A of the machine tool, B represents a rotation angle of the shaft B of the machine tool, and T_{W-ta} represents a matrix of transformation from a rotation angle of the machine tool to the cutter axis vector;
an equation of the feeding coordinate system is:
$$\{ \begin{matrix}{F}_{( i , k )} = \frac{{CC}_{( i + 1 , k )} - {CC}_{( i , k )}}{\vert {CC}_{( i + 1 , k )} - {CC}_{( i , k )} \vert} \\ {N}_{( i , k )} = ( {n}_{i} , {n}_{j} , {n}_{k} ) \\ {C}_{( i , k )} = {N}_{( i , k )} \times {F}_{( i , k )} \\ {O}_{F ( i , k )} = {CC}_{( i , k )} + R * {N}_{( i , k )}\end{matrix}$$
wherein CC_{(i+1,k)} and CC_{(i,k)} represent two successive cutter contact points in a k-th cutter path, while N_{(i,k)} represents a surface normal vector of the tool at current cutter location point; C_{(i,k)} represents an intersecting feeding direction at the current cutter location point CL_{(i,k)}; O_{F}_{_{(i,k)}} represents an origin of the feeding coordinate system; F_{(i,k)} represents a feeding direction at an i-th cutter location point in the k-th cutter path, R represents a radius of a ball-end milling cutter, and nᵢ, nⱼ and nₖ represent coordinate values of the surface normal vector;
defining feeding coordinates in the workpiece coordinate system, and a transformational relation between the feeding coordinates and the workpiece coordinate system is:
T_{F→W}=[F_{(i,k)}|C_{(i,k)}|N_{(i,k)}]_{3×3}
wherein [ ]_{3×3} represents a third-order matrix composed of the feeding direction, the intersecting feeding direction and the surface normal vector at the i-th cutter location point in the k-th cutter path;
the relational equation of the cutter axis vector with the shaft A and the shaft B of the machine tool is:
T_{W-ta}=T_{W-F}(T_{T-F})^{T},
wherein T_{W-F} represents a matrix of transformation from the workpiece coordinate system to the feeding coordinate system, while T_{T-F} represents the matrix of transformation from the cutter coordinate system to the feeding coordinate system, W represents the workpiece coordinate system, and T represents the torque of the matrix; and
determining feasible regions of a front rake angle and a side rake angle corresponding to the cutter axis vector under the machine tool limitation constraint by combining the rotation stroke of the shaft A and the rotation stroke of the shaft B of the machine tool with the relational equation of the cutter axis vector with the shaft A and the shaft B of the machine tool.

5. The method for generating a machining cutter path for a curved deep cavity surface according to claim 1, wherein considering a non-interference constraint comprises the following steps:
detecting and avoiding interference at the beginning of path generation, and considering potential interference of the cutter with a curved workpiece surface;
considering interference detection performed after clamping the cutter by the cutter holder, and a formula of radius variation of the cutter along the cutter axis in a cutting plane of axis Z of the cutter coordinate system O_{T}−X_{T}Y_{T}Z_{T} is:
$$r ( z ) = \{ \begin{matrix}{R}_{1} + \sqrt{{R}_{2}^{2} - {z}^{2}} , - {R}_{2} \leq z \leq 0 \\ {R}_{1} + {R}_{2} , 0 < z < {L}_{1} \\ \frac{{R}_{4} ( {L}_{1} + {L}_{2} - z ) + {R}_{3} ( z - {L}_{1} )}{{L}_{2}} , {L}_{1} < z < {L}_{1} + {L}_{2} \\ {R}_{4} , {L}_{1} + {L}_{2} < z < {L}_{1} + {L}_{2} + {L}_{3} \\ {R}_{5} , {L}_{1} + {L}_{2} + {L}_{3} < z < {L}_{1} + {L}_{2} + {L}_{3} + {L}_{4}\end{matrix}$$
wherein r(z) is a radius at a different height along the cutter axis, while L₁ represents a length of the cutter holder, L₂, L₃, L₄ represent lengths of different portions of a heat-shrinkable tool holder, R₁ and R₂ represent a bottom face corner radius and a cutter radius of an annular milling cutter, and R₃, R₄, R₅ represent radius values of different portions of the heat-shrinkable cutter holder;
discretizing the curved deep cavity surface into a point cloud according to a certain accuracy requirement, judging whether each point in the point cloud falls inside the curved cutter surface, confirming that interference occurs between the cutter and the curved workpiece surface if at least one point in the point cloud is inside the cutter; otherwise, confirming no interference occurs;
for any point P in the point cloud data of the curved deep cavity surface, setting P′ as a projection of the point P on the cutter axis, and expressing P′ as:
P′=O_{T}+λ·ta
wherein ta is the cutter axis vector, while λ is a coefficient of a distance from P′ to the origin O_{T} of the cutter coordinate system;
obtaining the z coordinate value of the P projection on the cutter axis after obtaining P′, substituting the z coordinate value into the formula of radius variation of the cutter along the cutter axis, confirming that the point is in space outside two ends of the cutter if the value of z is not within the range of the formula of radius variation of the cutter along the cutter axis, and in this case, confirming that the point is not within the curved cutter surface and no interference occurs; if the value of z is within the range of the formula of radius variation of the cutter along the cutter axis, substituting the value of z into the formula of radius variation of the cutter along the cutter axis for calculation, if |PP′|≥r(z) determining that the point P is located outside the curved cutter surface and no interference occurs; otherwise, determining that interference occurs;
changing the cutter axis vector, determining whether interference occurs for the cutter axis vector, and if no interference occurs, recording the posture of the cutter and constructing a feasible region of cutter posture without interference.

6. The method for generating a machining cutter path for a curved deep cavity surface according to claim 1, wherein considering a non-chattering constraint comprises following steps:
obtaining a posture stability diagram based on a contact area of the cutter and workpiece, and determining a feasible region of cutter posture for stable machining;
based on NX12.0 secondary development, extracting the contact area of the cutter and workpiece at each cutter location point during machining, and obtaining a cut-in and cut-out angle of each cutting infinitesimal element at this cutter location point through an equation
$${ϕ}_{b} = arc tan ( \frac{{x}_{{P}_{b}}}{{y}_{{P}_{b}}} ) , 0 \leq {ϕ}_{b} \leq 2 π ,$$
wherein ϕ_{b} represents an immersion angle, while xp_{b} represents x coordinate value of any point P_{b}, and yp_{b} represents y coordinate value of any point P_{b};
for a cutter location point, extracting the contact area once through NX12.0 secondary development application; and
after obtaining the contact area, obtaining the posture stability diagram by combining a universal cutting model of a milling cutter and the full-discrete method, thereby obtaining the feasible region of cutter posture for stable machining.

7. The method for generating a machining cutter path for a curved deep cavity surface according to claim 1, wherein optimizing a shortest path and outputting an optimized cutter path comprise following steps:
after obtaining the feasible regions of cutter axis vector for each cutter location point based on the machine tool limitation constraint, the non-interference constraint and the non-chattering constraint, outputting the optimized cutter path, which requires confirmation of the exact cutter axis vector corresponding to each cutter location point;
determining the cutter axis vector corresponding to each cutter location point based on the Dijkstra shortest path fairing method, and outputting the optimized cutter location file;
selecting corresponding post-processing according to the actual machine tool and outputting the final optimized cutter path.
